(19) United States
(12) Patent Application Publication
(10) Pub. No.: US 2017/0008794 A1
(43) Pub. Date: Jan. 12, 2017

(54) Glass Substrate Cutting Apparatus and Cutting Method Thereof

(71) Applicant: SHENZHEN CHINA STAR OPTOELECTRONICS TECHNOLOGY, Shenzhen, Guangdong (CN)

(72) Inventor: Huping JIA, Shenzhen, Guangdong (CN)

(21) Appl. No.: 14/647,117

(22) PCT Filed: May 12, 2014
(86) PCT No.: PCT/CN2014/077248

§ 371 Date: May 25, 2015

(30) Foreign Application Priority Data
Mar. 27, 2014 (CN) 201410118232.7

(51) Int. Cl. C03B 33/033; B26F 3/00; C03B 33/03

(52) U.S. Cl. CPC C03B 33/033; C03B 33/03; B26F 3/002

(57) ABSTRACT

The invention provides a glass substrate cutting apparatus, comprising workbenches, cutting knives and rollers, wherein a glass substrate is transferred on the workbenches; the cutting knives comprise an upper cutting knife and a lower cutting knife that are arranged the upper end and the lower end of the glass substrate respectively with knife edges opposite to each other, so as to cut the glass substrate into two halves from the upper side and the lower side of the glass substrate; the rollers are arranged at the upper end of the glass substrate; and the glass substrate can be pressed to break down along a cutting crack on the glass substrate. The cutting apparatus further comprises high-pressure nozzles that are arranged between the cutting knifes and the rollers and can eject a high-pressure airflow along the cutting crack so as to accelerate the breakage of the glass substrate.

### FIELD OF THE INVENTION

The present invention relates to a glass substrate manufacturing apparatus and a manufacturing method, and in particular, to a glass substrate cutting apparatus and a cutting method thereof.

### BACKGROUND OF THE INVENTION

Glass substrates of existing LCD panels need to be combined with color filters and to be filled with liquid crystal during manufacturing, and then are cut into sizes as required. The glass substrate is generally cut by a cutting knife in a way of back and forth so as to cut the glass substrate into two halves. At this time, the cutting head of the cutting knife is easy to wear and becomes blunt for its long-term use. It is difficult to break down the glass substrate due to a shallower crack while cutting the glass. Repeated cutting will affect the cutting quality of the glass substrate, thus being incapable of meeting the refined production requirements for the LCD panels.

### SUMMARY OF THE INVENTION

Based on the defects of the prior art, the present invention mainly aims at providing a glass substrate cutting apparatus and a cutting method thereof with high cutting efficiency and good quality.

The present invention provides a glass substrate cutting apparatus, which comprises workbenches, cutting knives and rollers. A glass substrate is transferred on the workbenches. The cutting knives comprise an upper cutting knife and a lower cutting knife that are arranged the upper end and the lower end of the glass substrate respectively with knife edges opposite to each other, so as to cut the glass substrate into two halves from the upper side and the lower side of the glass substrate. The rollers are arranged at the upper end of the glass substrate; and the glass substrate can be pressed to break down along a cutting crack on the glass substrate. The cutting apparatus further comprises high-pressure nozzles which can eject a high-pressure airflow along the cutting crack so as to accelerate the breakage of the glass substrate.

Preferably, the cutting apparatus further comprises an air ejection control unit that is electrically connected with the high-pressure nozzle and comprises a solenoid valve and a heater that are electrically connected with each other. The solenoid valve is electrically connected with the high-pressure nozzle; and the high-pressure airflow after being heated by the heater is controlled to educe from the high-pressure nozzle through on-off of the solenoid valve. The crack of the glass substrate is deepened through the high-pressure airflow and then accelerate the breakage of the glass substrate.

Preferably, the high-pressure nozzles are arranged between the cutting knifes and the rollers. The inner diameter of the outlet end of the high-pressure nozzle is 1˜2 mm, and the aperture of the nozzle is small, so that the pressure of the airflow educed from the nozzle is increased, which is beneficial to the breakage of the glass substrate. The pressure of the high-pressure airflow ejected from the high-pressure nozzles is 0.5˜1.5 Mpa and the temperature is a normal temperature of 25-35° C.

Preferably, two high-pressure nozzles are symmetrically and respectively arranged at the upper end and the lower end of the glass substrate. The crack is blown under high pressure through the high-pressure nozzles at the upper end and the lower end of the glass substrate so that the crack is evenly stressed, so as to avoid bending and deforming of the glass substrate due to uneven stress in some parts.

Preferably, the cutting knife, the high-pressure nozzle and the crack at the same side are on the same line. A fore-and-aft distance between the cutting knife and the high-pressure nozzle is 1˜3 cm. The roller is arranged nearby the high-pressure nozzle, deviating from the crack. A left-and-right distance between the roller and the high-pressure nozzle is 1˜3 cm; that is, a distance between the roller and the crack is 1˜3 cm. The glass substrate can be pressed at both sides of the crack by the rollers, so that the glass substrate is pressed and broken down at the crack. If the distance between the roller and the crack is oversized, a force bearing point of the glass substrate will be affected, which will result in breakage of other positions of the glass substrate, and thus affecting the molding quality of the glass substrate.

The invention further provides a method for cutting glass substrate, comprising the following steps of:

step 1) steadily placing the glass substrate on a workbench, and then adjusting the position of the cutting knife;

step 2) starting cutting, wherein the upper cutting knife and the lower cutting knife move towards the same direction to form a crack on the glass substrate;

step 3) starting the air ejection control unit to eject the high-pressure airflow along the crack through the high-pressure nozzle to deepen the crack on the glass substrate; and

step 4) pressing the glass substrate and pushing the rollers to press the glass substrate along the crack so as to break down the glass substrate into two halves.

Preferably, the pressure of the high-pressure airflow is 0.5˜1.5 Mpa in step 3). The stress strength on the crack is increased by the high-pressure airflow.

The cutting of the glass substrate and the air ejection of the high-pressure nozzle are performed synchronously to deepen the crack of the glass substrate and accelerate the breakage of the glass substrate.

Preferably, a distance between the moving track of the roller and the crack is 1˜3 cm and the rollers press the glass substrate along a reverse track of cutting.

Compared with the prior art, and by additionally arranging the high-pressure nozzles, the glass substrate cutting apparatus can eject the high-pressure airflow towards the crack so as to increase the pressure of the crack and deepen the crack while cutting, and thus achieving an effect of rapid breakage. The glass substrate is evenly stressed while being broken off by setting the distance between the cutting knife and the roller, so as to avoid breakage of other positions of the glass substrate. The cutting efficiency and the cutting quality are accelerated by blowing the crack with the high-pressure air. Meanwhile, the ejected high-pressure airflow may not contaminate the glass substrate, and thus is safer and more reliable with respect to ejecting other medium.

### BRIEF DESCRIPTION OF THE DRAWINGS

FIG. 1 is a schematic structural diagram of a glass substrate cutting apparatus of the invention; and

FIG. 2 is a schematic circuit diagram of a glass substrate cutting apparatus of the invention.

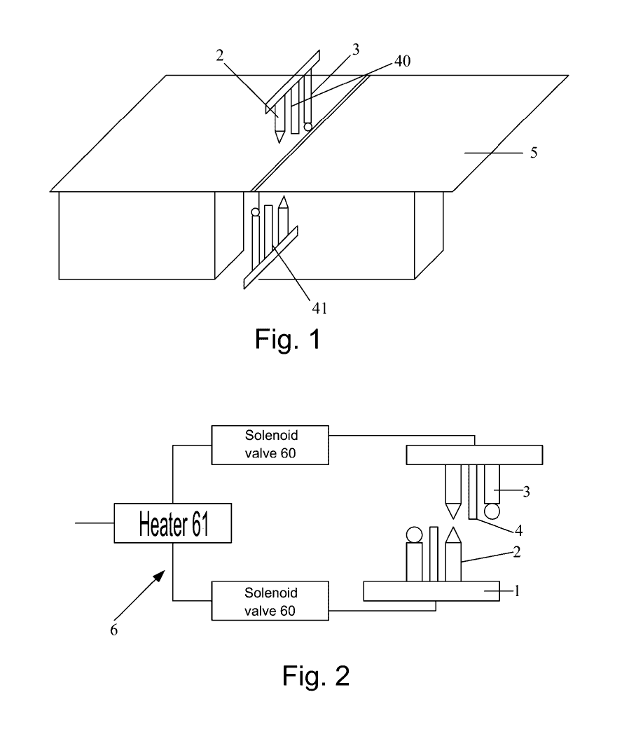

### DETAILED DESCRIPTION OF PREFERRED EMBODIMENTS

To speed up the cutting efficiency of the glass substrate and improve the cutting quality, the invention provides a glass substrate cutting apparatus, comprising workbenches 1, cutting knives 2, rollers 3 and high-pressure nozzles 4. The cutting knives 2, the rollers 3 and the high-pressure nozzles 4 are arranged in pair and symmetrically mounted at the upper end and the lower end of the glass substrate 5. A glass substrate 5 is transferred on the workbenches 1. The cutting knives 2 comprise an upper cutting knife 20 and a lower cutting knife 21 that are arranged at the upper end and the lower end of the glass substrate 5 respectively with knife edges opposite to each other, so as to cut the glass substrate 5 into two halves from the upper side and the lower side of the glass substrate. The rollers 3 are arranged at the upper end of the glass substrate 5; and the glass substrate 5 can be pressed to break down along a cutting crack on the glass substrate 5. The high-pressure nozzles 4 are arranged between the cutting knives 2 and the rollers, and can eject a high-pressure airflow along the cutting crack so as to accelerate the breakage of the glass substrate 5.

The workbenches 1 comprise a first workbench 10 and a second workbench 12. The glass substrate 5 is transferred from the first workbench 10 to the second workbench via a conveyor belt. A cutting component comprises the cutting knives 2, the rollers and the high-pressure nozzles 4, and is arranged between the two workbenches. When the middle of the glass substrate 5 is transmitted to the position of the cutting component, a cutting procedure starts.

Preferably, the high-pressure nozzles 4 comprise an upper nozzle 40 and a lower nozzle 41, which are symmetrically and respectively arranged at the upper end and the lower end of the glass substrate 5. The crack is blown under high pressure through the high-pressure nozzles 4 at the upper end and the lower end of the glass substrate 5 so that the crack is evenly stressed, so as to avoid bending and deforming of the glass substrate 5 due to uneven stress in some parts. The cutting apparatus further comprises an air ejection control unit 6 that is electrically connected with the high-pressure nozzle 4 and comprises two solenoid valves 60 and a heater 61 that are electrically connected with each other. The two solenoid valves are electrically and respectively connected with the upper nozzle 40 and the lower nozzle 41 to respectively control the breakage of the high-pressure airflow in the upper nozzle 40 and the lower nozzle 41. The high-pressure airflow after being heated by the heater 61 is controlled to educe from the high-pressure nozzle 4 through on-off of the solenoid valves 60; and the crack of the glass substrate 5 is deepened by the high-pressure airflow to accelerate the breakage of the glass substrate 5.

Preferably, the inner diameter of the outlet end of the high-pressure nozzle 4 is 1˜2 mm, and the aperture of the nozzle is small, so that the pressure of the airflow educed from the nozzle is increased, which is beneficial to the breakage of the glass substrate. The pressure of the high-pressure airflow ejected from the high-pressure nozzles is 0.5˜1.5 Mpa and the temperature is a normal temperature. The greater the airflow pressure is, the greater the pressure produces on the crack, and the deeper the crack becomes, thus achieving an effect of rapid breakage.

Preferably, the cutting knife 2, the high-pressure nozzle 4 and the crack at the same side are on the same line. A fore-and-aft distance between the cutting knife 2 and the high-pressure nozzle 4 is 1˜3 cm. The roller 3 is arranged nearby the high-pressure nozzle 4, deviating from the crack. A left-and-right distance between the roller 3 and the high-pressure nozzle 4 is 1˜3 cm; that is, a distance between the roller 3 and the crack is 1˜3 cm. In this way, the cutting knives 2 and the high-pressure nozzle 4 can cut the glass substrate on the same line to form the crack; however, the rollers 3 deviate from the crack when pressing the glass substrate 5. The rollers 3 can press the glass substrate 5 at both sides of the crack, so that the glass substrate 5 is pressed and broken off in the crack. If the distance between the roller 3 and the crack is oversized, a force bearing point of the glass substrate 5 will be affected, which will result in breakage of other positions of the glass substrate, and thus affecting the molding quality of the glass substrate.

The invention further provides a method for cutting glass substrate, comprising the following steps of:

step 1) steadily placing the glass substrate on the workbenches, and then adjusting the position of the cutting knives via a position adjusting device, so as to make the cutting component opposite and perpendicular to the middle of the glass substrate to ensure that the cut crack is smooth;

step 2) starting cutting, wherein the upper cutting knife and the lower cutting knife move towards the same direction to form a crack on the glass substrate;

step 3) starting the air ejection control unit and switching on the solenoid valves to eject the high-pressure airflow along the crack through the high-pressure nozzle to deepen the crack on the glass substrate; and

step 4) pressing the glass substrate, pushing the rollers to press the glass substrate along the crack to break down the glass substrate into two halves, and then vacuumizing the cut glass substrate from the second workbench.

Preferably, the pressure of the high-pressure airflow is 0.5˜1.5 Mpa in step 3). The stress strength on the crack is increased by the high-pressure airflow.

Preferably, a distance between a moving track of the roller and the crack is 1˜3 cm and the roller presses the glass substrate along a reverse track of cutting.

The cutting of the glass substrate and the air ejection of the high-pressure nozzle are performed synchronously to deepen the crack of the glass substrate and accelerate the breakage of the glass substrate. In the present invention, the high-pressure airflow is ejected by the high-pressure nozzle along the crack while cutting, so as to increase the depth of the original crack by at least one times. As a result, the cutting efficiency and the cutting quality are obviously improved, so that the glass substrate is easier to break down along the crack and the crack is smooth.

Compared with the prior art, and by additionally arranging the high-pressure nozzles, the glass substrate cutting apparatus can eject the high-pressure airflow towards the crack so as to increase the pressure of the crack and deepen the crack while cutting, and thus achieving an effect of rapid breakage. The glass substrate is evenly stressed while being broken off by setting the distance between the cutting knife and the roller, so as to avoid breakage of other positions of the glass substrate. The cutting efficiency and the cutting quality are accelerated by blowing the crack with the high-pressure air. Meanwhile, the ejected high-pressure airflow may not contaminate the glass substrate, and thus is safer and more reliable with respect to ejecting other medium.

What is claimed is:

1. A glass substrate cutting apparatus, comprising workbenches, cutting knives and rollers, wherein a glass substrate is transferred on the workbenches; the cutting knife comprises an upper cutting knife and a lower cutting knife that are arranged at the upper end and the lower end of the glass substrate respectively with knife edges opposite to each other, so as to cut the glass substrate into two halves from the upper side and the lower side of the glass substrate; the rollers are arranged at the upper end of the glass substrate; and the glass substrate can be pressed to break down along a cutting crack on the glass substrate; wherein the cutting apparatus further comprises high-pressure nozzles which can eject a high-pressure airflow along the cutting crack so as to accelerate the breakage of the glass substrate; and the high-pressure nozzles are arranged between the cutting knifes and the rollers.

2. The glass substrate cutting apparatus according to claim 1, wherein the cutting apparatus further comprises an air ejection control unit that is electrically connected with the high-pressure nozzle and comprises a solenoid valve and a heater that are electrically connected with each other; the solenoid valve is electrically connected with the high-pressure nozzle; and the high-pressure airflow after being heated by the heater is controlled to educe from the high-pressure nozzle through on-off of the solenoid valve.

3. The glass substrate cutting apparatus according to claim 2, wherein the inner diameter of the outlet end of the high-pressure nozzle is 1˜2 mm.

4. The glass substrate cutting apparatus according to claim 3, wherein the pressure of the high-pressure airflow ejected from the high-pressure nozzle is 0.5˜1.5 Mpa and the temperature is 25-35° C.

5. The glass substrate cutting apparatus according to claim 1, wherein a distance between the cutting knife and the high-pressure nozzle is 1˜3 cm; and a distance between the roller and the high-pressure nozzle is 1˜3 cm.

6. A method for cutting glass substrate by using the apparatus of claim 1, comprising the following steps of:
step 1) steadily placing the glass substrate on a workbench, and then adjusting the position of the cutting knife;
step 2) starting cutting, wherein the upper cutting knife and the lower cutting knife move towards the same direction to form a crack on the glass substrate;
step 3) starting the air ejection control unit to eject the high-pressure airflow along the crack through the high-pressure nozzle to deepen the crack on the glass substrate; and
step 4) pressing the glass substrate and pushing the rollers to press the glass substrate along the crack so as to break down the glass substrate into two halves.

7. The method for cutting glass substrate according to claim 6, wherein the pressure of the high-pressure airflow is 0.5˜1.5 Mpa in step 3).

8. The method for cutting glass substrate according to claim 6, wherein the cutting of the glass substrate and the air ejection of the high-pressure nozzle are performed synchronously.

9. The method for cutting glass substrate according to claim 6, wherein a distance between the moving track of the roller and the crack is 1˜3 cm and the roller presses the glass substrate along a reverse track of cutting.

10. A glass substrate cutting apparatus, comprising workbenches, cutting knives and rollers, wherein a glass substrate is transferred on the workbenches; the cutting knife comprises an upper cutting knife and a lower cutting knife that are arranged at the upper end and the lower end of the glass substrate respectively with knife edges opposite to each other, so as to cut the glass substrate into two halves from the upper side and the lower side of the glass substrate; the rollers are arranged at the upper end of the glass substrate; and the glass substrate can be pressed to break down along a cutting crack on the glass substrate; wherein the cutting apparatus further comprises high-pressure nozzles which can eject a high-pressure airflow along the cutting crack so as to accelerate the breakage of the glass substrate.

11. The glass substrate cutting apparatus according to claim 10, wherein the high-pressure nozzles are arranged between the cutting knifes and the rollers.

12. The glass substrate cutting apparatus according to claim 10, wherein the cutting apparatus further comprises an air ejection control unit that is electrically connected with the high-pressure nozzle and comprises a solenoid valve and a heater that are electrically connected with each other; the solenoid valve is electrically connected with the high-pressure nozzle; and the high-pressure airflow after being heated by the heater is controlled to educe from the high-pressure nozzle through on-off of the solenoid valve.

13. The glass substrate cutting apparatus according to claim 11, wherein the inner diameter of the outlet end of the high-pressure nozzle is 1˜2 mm.

14. The glass substrate cutting apparatus according to claim 12, wherein the pressure of the high-pressure airflow ejected from the high-pressure nozzle is 0.5˜1.5 Mpa and the temperature is 25-35° C.

15. The glass substrate cutting apparatus according to claim 10, wherein a distance between the cutting knife and the high-pressure nozzle is 1˜3 mm.

16. The glass substrate cutting apparatus according to claim 10, wherein a distance between the roller and the high-pressure nozzle is 1˜3 mm.
